(19) United States
(12) Patent Application Publication
(10) Pub. No.: US 2013/0043614 A1
(43) Pub. Date: Feb. 21, 2013

(54) METHOD FOR MANUFACTURING ENDLESS BELT

(71) Applicants: Yuichi YASHIKI, Kanagawa (JP); Daisuke TANEMURA, Kanagawa (JP); Masaru SUZUKI, Kanagawa (JP)

(72) Inventors: Yuichi YASHIKI, Kanagawa (JP); Daisuke TANEMURA, Kanagawa (JP); Masaru SUZUKI, Kanagawa (JP)

(73) Assignee: FUJI XEROX CO., LTD., Tokyo (JP)

(21) Appl. No.: 13/350,130

(22) Filed: Jan. 13, 2012

(30) Foreign Application Priority Data
Aug. 16, 2011 (JP) 2011-178053

(51) Int. Cl. B29C 41/32

(52) U.S. Cl. 264/104

(57) ABSTRACT

A method for manufacturing an endless belt includes coating a solution containing a polyimide precursor and conductive particles on the circumferential surface of a core to form a first coating film, drying the first coating film so that the residual amount of a solvent of the first coating film falls within a range of from about 10% to about 20% in respective portions, coating a solution containing a polyimide precursor and conductive particles on the dried first coating film to form a second coating film, drying the second coating film, heating the first dried coating film and the dried second coating film so that the polyimide precursors are imidized, and removing the first coating film and the second coating film heated in the heating of the first coating film and second coating film from a core.

### CROSS-REFERENCE TO RELATED APPLICATIONS

This application is based on and claims priority under 35 USC 119 from Japanese Patent Application No. 2011-178053 filed Aug. 16, 2011.

### BACKGROUND

### Technical Field

The present invention relates to a method for manufacturing an endless belt.

### SUMMARY

According to an aspect of the invention, there is provided a method for manufacturing an endless belt including: coating a solution containing a polyimide (PI) precursor and conductive particles on the circumferential surface of a core to form a first coating film; drying the first coating film so that the residual amount of a solvent of the first coating film falls within a range of from about 10% to about 22% in respective portions; coating a solution containing a PI precursor and conductive particles on the first coating film dried in the drying of the first coating film to form a second coating film; drying the second coating film; heating the first coating film dried in the drying of the first coating film and the second coating film dried in the drying of the second coating film so that the polyimide precursors are imidized; and removing the first coating film and the second coating film heated in the heating of the first coating film and second coating film from a core.

### BRIEF DESCRIPTION OF THE DRAWINGS

Exemplary embodiments of the present invention will be described in detail based on the following figures, wherein:

FIG. 1 is a drawing showing a process sequence related to a method for manufacturing a two-layer polyimide resin endless belt of the invention;

FIG. 2 is a view showing the configuration of a coating film forming apparatus used for a first coating film forming process (and a second coating film forming process) of FIG. 1;

FIG. 3 is a front view showing the configuration of a drying device used for a first coating film drying process (and a second coating film drying process) of FIG. 1;

FIG. 4 is a side view showing the configuration of the drying device used for the first coating film drying process (and the second coating film drying process) of FIG. 1;

FIG. 5 is a graph showing temperature distribution over the axial position of a core in the drying device of FIGS. 3 and 4;

FIG. 6 is a graph showing the relationship between the drying time of the first coating film by the drying device of FIGS. 3 and 4 and the residual amount of a solvent;

FIG. 7 is a cross-sectional view of a two-layer polyimide resin endless belt manufactured by the process sequence of FIG. 1;

FIG. 8 is a graph showing the relationship between the residual amount of a solvent of the first coating film in the first coating film drying process of FIG. 1, and back resistivity;

FIG. 9 is a graph showing back resistivity to the axial position of the two-layer polyimide resin endless belt manufactured by the process sequence of FIG. 1;

FIG. 10A is a plan view showing a circular electrode for measuring surface resistivity, and FIG. 10B is a cross-sectional view showing the circular electrode for measuring surface resistivity; and

FIG. 11A is a plan view showing a circular electrode for measuring volume resistivity, and FIG. 11B is a cross-sectional view showing the circular electrode for measuring volume resistivity.

### DETAILED DESCRIPTION

An example of an exemplary embodiment of a method for manufacturing an endless belt related to the invention, specifically, a method for manufacturing a two-layer polyimide resin endless belt will be described below with reference to the accompanying drawings.

First, a two-layer polyimide resin endless belt will be outlined.

The two-layer polyimide resin endless belt related to an exemplary embodiment of the invention is used as, for example, a transfer belt of an image forming apparatus. In the transfer belt, it is desired that the surface resistivity (hereinafter simply referred to as “surface resistivity”) of the surface of the belt, the surface resistivity (hereinafter simply referred to as “back resistivity”) of the back of the belt, and volume resistivity is settled within prescribed ranges, respectively, so that uneven concentration does not occur in a toner to be transferred. However, these resistivities that are the electrical properties of the belt are related to each other, and it is difficult to settle these resistivities in a prescribed value by a single-layer belt. For this reason, a two-layer polyimide resin endless belt that has a two-layer structure of an outer layer and an inner layer where the dispersion concentration of conductive particles is made different is adopted as the transfer belt.

A method for manufacturing the two-layer polyimide resin endless belt will be described below.

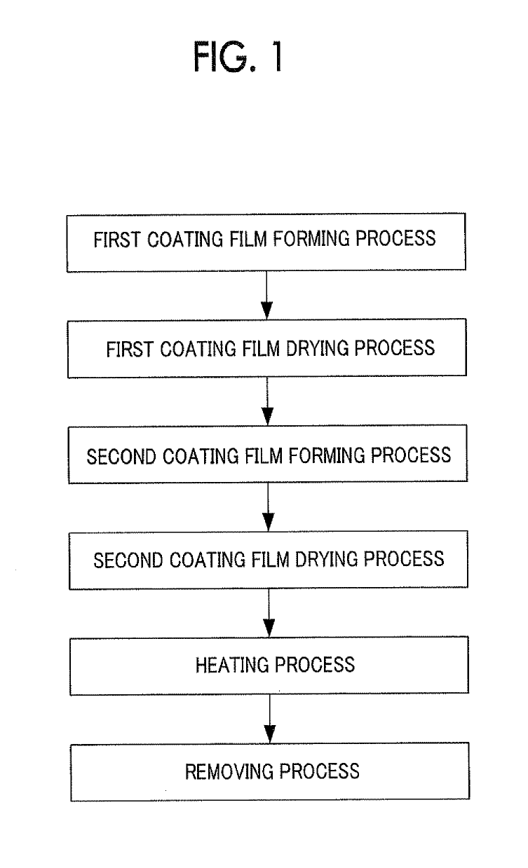

FIG. 1 shows a process sequence of the method for manufacturing the two-layer polyimide resin endless belt. As shown in FIG. 1, the two-layer polyimide resin endless belt is manufactured through a first coating film forming process, a first coating film drying process, a second coating film forming process, a second coating film drying process, a heating process, and a removing process. The respective processes will be specifically described below.

(First Coating Film Forming Process)

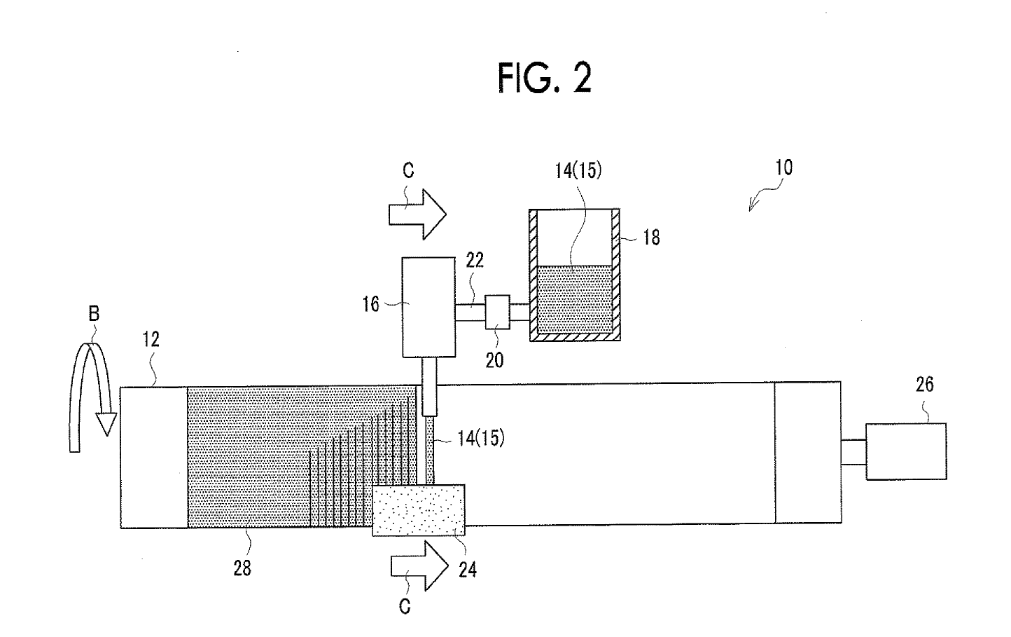

FIG. 2 shows the configuration of a coating film forming apparatus 10. In the coating film forming apparatus 10, a film forming resin solution 14 is discharged from a flow-down device 16, and is adhered to the circumferential surface of a core 12, while rotating a cylindrical core 12 to around the axis (indicated by an arrow B in the drawing) thereof with the axial direction of the core being made horizontal. The film forming resin solution 14 is supplied to the flow-down device 16 through a supply pipe 22 by a pump 20 from a tank 18 that stores the film forming resin solution 14. The film forming resin solution 14 adhering to the circumferential surface of the core 12 is smoothed by a paddle 24. The core 12 rotates in the direction of an arrow B around the axis, with the axial direction of a rotating device 26 being made horizontal.

The flow-down device 16 and the paddle 24 are supported so as to be movable in the axial direction of the core 12. By discharging the film forming resin solution 14 while moving the flow-down device 16 and the paddle 24 in the axial direction (the direction of an arrow C) of the core 12 with the core 12 being rotated at a preset rotating speed, the film forming resin solution 14 is spirally coated on the surface of the core 12 and smoothened by the paddle 24 to eliminate spiral stripes to form a seamless coating film 28. The coating film 28 formed in this first coating film forming process is referred to as a first coating film. Additionally, the coating film 28 formed in the second coating film forming process is referred to as a second coating film as will be described below. The film thickness of the first coating film is set to 200 μm (finished film thickness: 33 μm).

A polyimide resin (PI) precursor and conductive particles are contained in the film forming resin solution 14. To be precise, conductive particles are dispersed in a PI precursor solution to form the film forming resin solution 14.

The PI precursor solution is obtained by causing a tetracarboxylic dianhydride to react with a diamine component in a solvent. Although the types of the respective components are not particularly limited, it is preferable from the viewpoint of film strength that the PI precursor solution is obtained by causing an aromatic tetracarboxylic dianhydride to react with an aromatic diamine component.

Typical examples of the aromatic tetracarboxylic acid include pyromellitic dianhydride, 3,3′, 4,4′-biphenyl tetracarboxylic dianhydride, 3,3′,4,4′-benzophenone tetracarboxylic dianhydride, 2,3,4,4′-biphenyl tetracarboxylic dianhydride, 2,3,6,7-naphthalene tetracarboxylic dianhydride, 1,2,5,6-naphthalene tetracarboxylic dianhydride, 2,2-bis(3,4-dicarboxyphenyl)ether dianhydride, tetracarboxylic esters thereof, or mixtures of the above tetracarboxylic acids, and the like.

Working Examples of the aromatic diamine component include para-phenylenediamine, meta-phenylenediamine, 4,4′-diaminodiphenyl ether, 4,4′-diaminophenylmethane, benzidine, 3,3′-dimethoxybenzidine, 4,4′-diaminodiphenylpropane, 2,2-bis[4-(4-aminophenoxy)phenyl]propane, and the like.

Aprotic polar solvents, such as N-methylpyrrolidone, N,N-dimethylacetamide, and acetamide, are used as the solvent of the PI precursor solution. Although there is no limit to the concentration, viscosity, or the like of the solution, the solid content concentration of the solution is desirably from 10% by mass to 40% by mass, and the viscosity of the solution is desirably 1 Pa·s or more and 100 Pa·s or less.

Typical examples of the conductive particles that are dispersed in the PI precursor solution include carbon-based substances, such as carbon black, carbon fiber, carbon nanotube, and graphite, metals or alloys, such as copper, silver, and aluminum, conductive metal oxides, such as tin oxide, indium oxide, and antimony oxide, whisker such as potassium titanate, and the like. Among them, carbon black is particularly preferable from the viewpoint of dispersion stability in a liquid, development of semiconductivity, costs, and the like.

As methods for dispersing the conductive particles, publicly-known methods using a ball mill, a sand mill (beads mill), a jet mill (opposing collision type dispersing machine), and the like may be employed. As a dispersing auxiliary agent, a surfactant, a leveling agent, or the like may be added. It is preferable that the dispersion concentration of the conductive particles is from 10 parts to 40 parts, particularly from 15 parts to 35 parts, with respect to a resin component 100 parts (parts by mass; this is also the same in the following description).

In this exemplary embodiment, specifically, the film forming resin solution 14 is formed by mixing carbon black (product name: “Special Black 4” manufactured by Degussa Hywuls Corporation) with 100 parts by mass of PI precursor solution (product name: “U varnish” manufactured by Ube Industries, Ltd., the concentration of the solid content is 18%, and the solvent is N-methylpyrrolidone) in a solid content mass ratio of 22.4%, and then dispersing the mixed solution by the opposing collision type dispersing machine (“Geanus PY” manufactured by Geanus Co., Ltd).

In addition, it is particularly preferable that the material of the core 12 is stainless steel in terms of workability or durability. Although it is necessary that the width (the axial length) of the core 12 is equal to or more than a targeted belt width, it is desirable that the width of the core is about 10% to 40% longer than the targeted belt width in order to secure a marginal region with respect to an ineffective region generated at an end. The length (circumference) of the core 12 is made equal to or slightly longer than the targeted belt length.

(First Coating Film Drying Process)

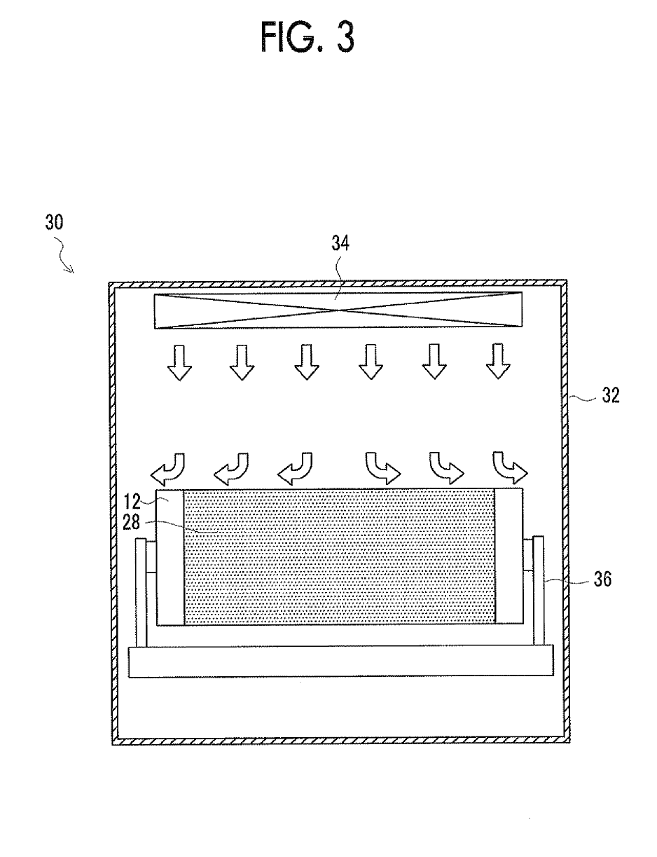

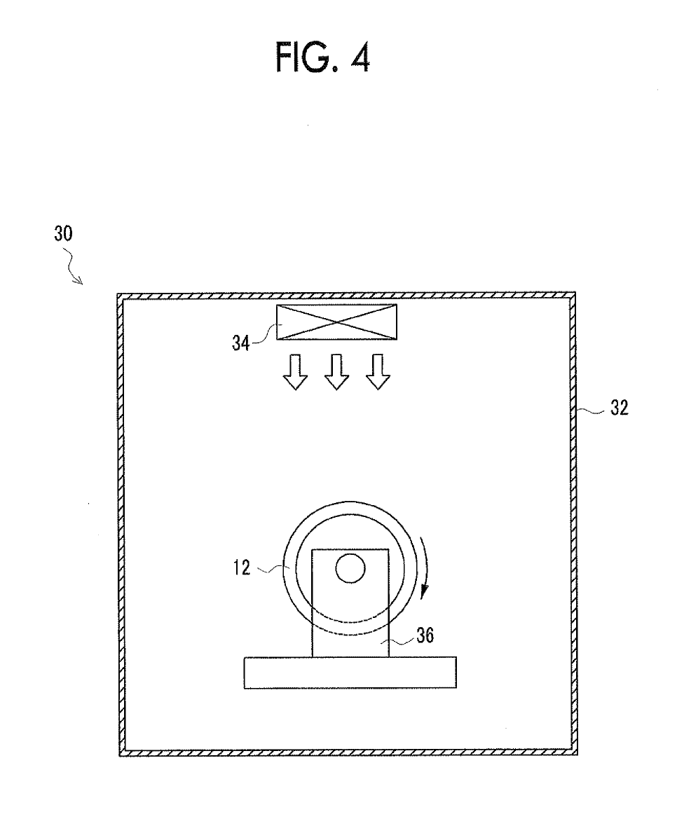

FIGS. 3 and 4 show the configuration of the drying device 30. The drying device 30 includes a hot-air blower 34 that blows out hot air (heated air) from above in a drying furnace 32, and a supporting platform 36 that rotatably supports the core 12. The core 12 on which the first coating film is formed in the first coating film forming process is put on the supporting platform 36 and rotated by a drive device (not shown). Then, the hot air blown out from the hot-air blower 34 is blown against the core 12 over its overall length to dry the first coating film. The temperature of the hot air blown out from the hot-air blower 34 is set to a range of from 100° C. to 200° C.

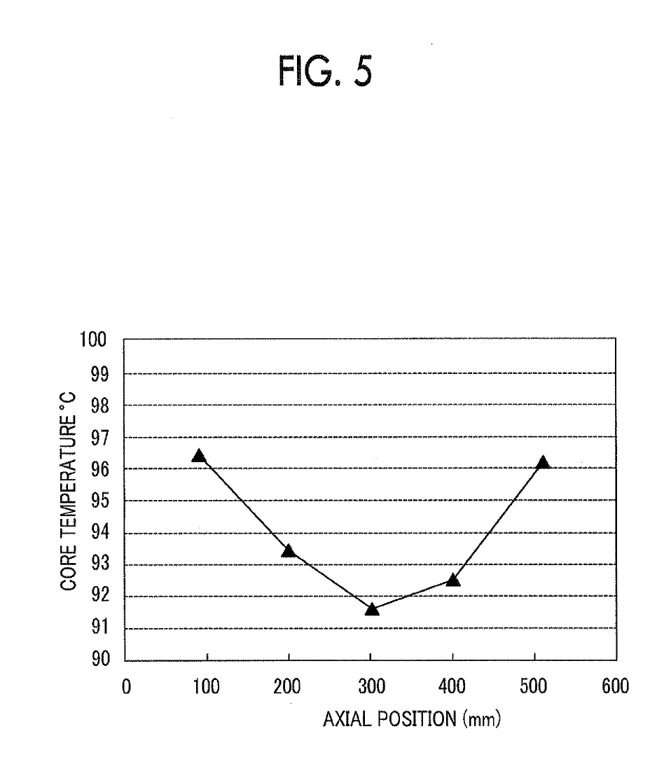

FIG. 5 shows temperature distribution to the axial position of the core 12 in this drying device 30. Specifically, the temperature distribution to the axial position of the core 12 when the hot air set to 150° C. is blown out for 10 minutes while rotating the core 12 at 10 rpm is shown. As shown in the drawing, the temperature to the axial position of the core 12 is not constant, and the temperature at both ends of the core is higher compared to that at the central portion of the core. It is believed that, as shown in FIG. 3, this is because hot air is spreading from the central portion of the core to both ends thereof in the drying device 30.

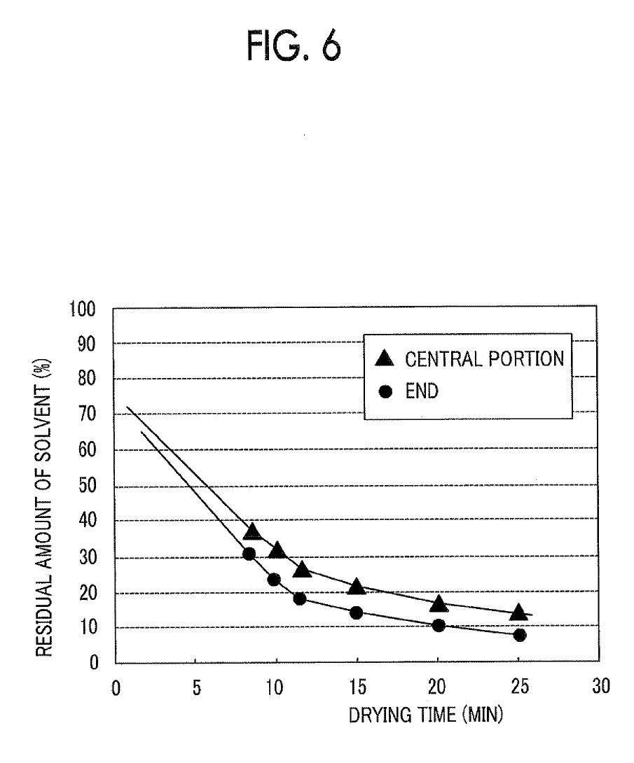

FIG. 6 shows the relationship between the drying time of the first coating film by the drying device 30 and the residual amount of a solvent. In addition, the core is rotated at 10 rpm and hot air is set to 150° C. A curve shown by black dot plotting in the drawing represents the residual amount of a solvent at an axial end of the first coating film. A curve shown by black triangle plotting in the drawing represents the residual amount of a solvent at an axial central portion of the first coating film. Although both the residual amounts of a solvent of the first coating film at the axial central portion and the axial end decrease as the drying time becomes longer as shown in the drawing, when compared in the same drying time, the residual amount of a solvent at the axial end is smaller than the residual amount of a solvent of the axial central portion. This is because the temperature to the axial position of the core 12 is not constant as shown in FIG. 5, and the drying speed of the first coating film at the axial end is higher than the drying speed of the axial central portion of the first coating film.

As such, it is difficult to dry the first coating film without unevenness in the axial direction in the drying device 30 of the type in which hot air is blown by the hot-air blower 34, and several percents of uneven dryness occur in terms of the residual amount of a solvent. Even so, it is sufficiently possible that the difference between the residual amounts of a solvent of the first coating film in respective portions is settled within 10% or less by adjusting both or either of the drying time and the hot-air temperature. Thus, in the first coating film drying process in the present exemplary embodiment, the first coating film is dried so that the residual amounts of a solvent of the first coating film fall within a range of from 10% to 22% (or from about 10% to about 22%) in respective portions. The reason will be described below.

(Second Coating Film Forming Process)

In the second coating film forming process, the second coating film is formed on the first coating film dried by the first coating film drying process, using the coating film forming apparatus 10 again. A film forming resin solution 15 (refer to FIG. 2) used for the formation of the second coating film is made different from the film forming resin solution 14 used for the formation of the first coating film in terms of the content of conductive particles.

In this exemplary embodiment, specifically, the film forming resin solution 15 is formed by mixing carbon black (product name: “Special Black 4” manufactured by Degussa Hywuls Corporation) with 100 parts by mass of PI precursor solution (product name: “U varnish” manufactured by Ube Industries, Ltd., the concentration of the solid content is 18%, and the solvent is N-methylpyrrolidone) in a solid content mass ratio of 20.4%, and then dispersing the mixed solution by the opposing collision type dispersing machine (“Geanus PY” manufactured by Geanus Co., Ltd). In addition, the film thickness of the second coating film is set to 400 μm (finished film thickness: 67 μm).

(Second Coating Film Drying Process)

In the second coating film drying process, the second coating film formed in the second coating film forming process is dried, using the drying device again. Since the uneven dryness of the second coating film does not affect the thickness of a high-concentration conductive particle layer 44 to be descried below, the second coating film may be dried so that the residual amount of a solvent falls within a range of from 20% to 50% (or from about 20% to about 50%). In addition, if the residual amount of a solvent exceeds 50%, creases may be generated in the second coating film or the second coating film may be made white, and if the residual amount of a solvent is less than 20%, a crack may be generated in the second coating film.

(Heating Process)

In the heating process, the core 12 on which the first coating film and the second coating film are formed is put into a proper heating furnace, and is heat-treated for 20 minutes to 60 minutes (or about 20 minutes to about 60 minutes) preferably at 250° C. to 450° C. (or about 250° C. to about 450° C.), more preferably 300° C. to 350° C. (or about 300° C. to about 350° C.) This causes the imidization reaction of the PI precursors of the first coating film and the second coating films, whereby two-layer structured PI resin films are formed.

In addition, in this heating process, the temperature may be raised in a stepwise manner or gradually at constant speed before reaching the final temperature of heating.

(Removing Process)

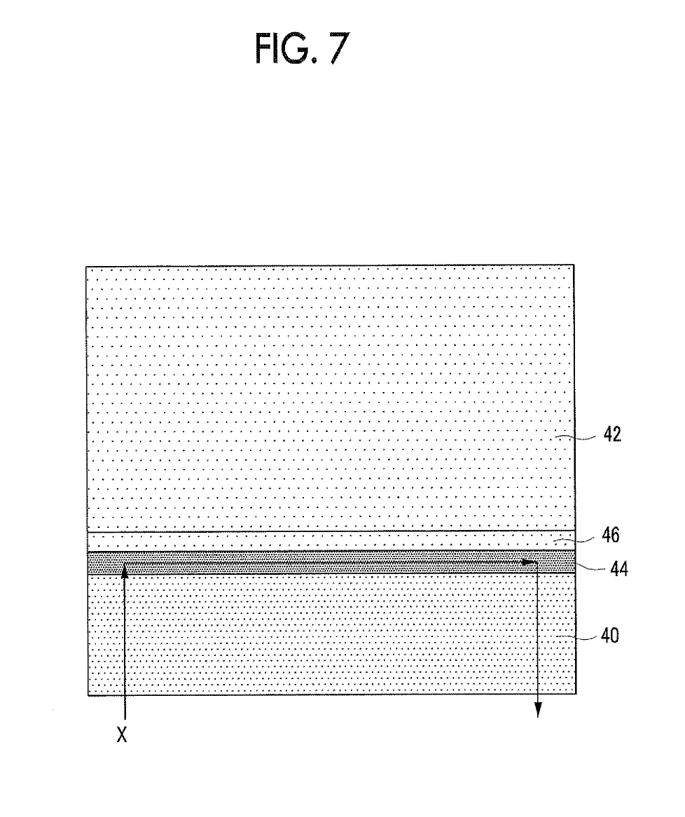

After heat treatment in the heating process, two-layer structured PI resin films are removed from the core 12. A two-layer polyimide resin endless belt having a PI resin film formed from the first coating film as an inner layer 40 (refer to FIG. 7) and a PI resin film formed from the second coating film as an outer layer 42 (refer to FIG. 7) is obtained.

In addition, since the ends of the two-layer polyimide resin endless belt may have uneven thickness, the ends are cut off if necessary. Additionally, when this two-layer polyimide resin endless belt is used as various kinds of belt members, such as a transfer belt of an image forming apparatus, the belt is subjected to drilling, ribbing, or the like if necessary.

(As for Residual Amount of Solvent of First Coating Film)

Next, the technical meaning of settling the residual amount of a solvent of the first coating film in the first coating film drying process within a range of from 10% to 22% in respective portions will be described.

FIG. 7 shows a cross-sectional view of the two-layer polyimide resin endless belt manufactured through the above respective processes. As shown in the drawing, the high-concentration conductive particle layer 44 located nearer to the inner layer 40 and the low-concentration conductive particle layer 46 located nearer to the outer layer 42 are formed between the inner layer 40 and the outer layer of the two-layer polyimide resin endless belt. The formation of the high-concentration conductive particle layer 44 and the low-concentration conductive particle layer 46 results from the phenomenon that the PI precursor of the PI precursor and the conductive particles oozes out toward the second coating film at the boundary surface between the first coating film and the second coating film and the conductive particles are left behind on the first coating film side, when the second coating film is coated on the first coating film dried in the second coating film forming process. In addition, although the two-layer polyimide resin endless belt can also be precisely said to have the four-layer structure of the inner layer 40, the high-concentration conductive particle layer 44, the low-concentration conductive particle layer 46, and the outer layer 42, the above structure is referred to as two-layer structure because the high-concentration conductive particle layer 44 and the low-concentration conductive particle layer 46 are thin compared to the inner layer 40 and the outer layer 42.

The concentration of conductive particles of the high-concentration conductive particle layer 44 is higher than the concentration of conductive particles of the inner layer 40, and the concentration of conductive particles of the low-concentration conductive particle layer 46 is lower than the concentration of conductive particles of the inner layer 40. For this reason, the surface current at the inner layer 40 of the two-layer polyimide resin endless belt flows through the high-concentration conductive particle layer 44, as indicated by an arrow X in the drawing. That is, the surface resistivity (back resistivity) at the inner layer 40 of the two-layer polyimide resin endless belt depends on the thickness of the high-concentration conductive particle layer 44. In other words, the back resistivity becomes smaller as the layer thickness of the high-concentration conductive particle layer 44 increases, and the back resistivity becomes larger as the layer thickness of the high-concentration conductive particle layer 44 decreases.

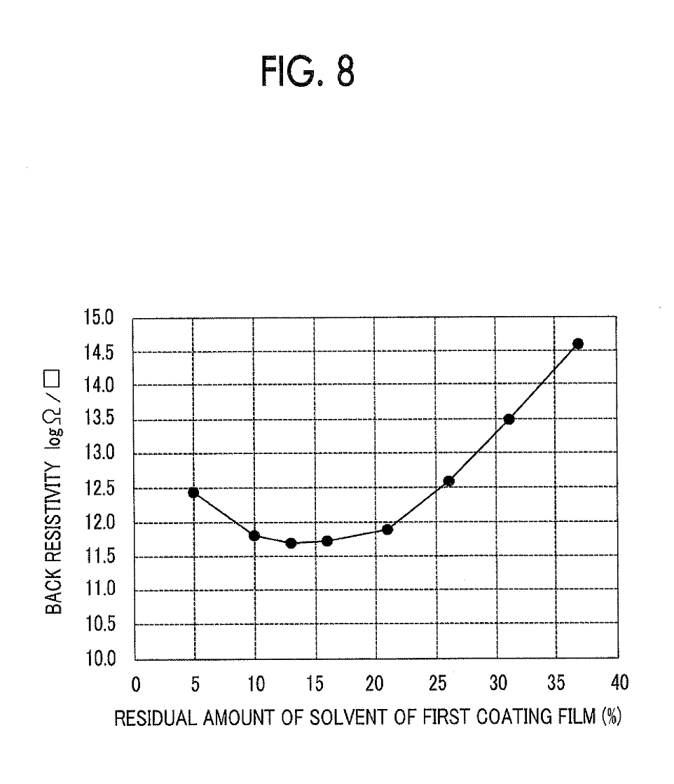

FIG. 8 shows the relationship between the residual amount of a solvent of the first coating film in the first coating film drying process, and the back resistivity. As shown in the drawing, although the back resistivity is low and almost constant within a range where the residual amount of a solvent is from 10% to 22%, the back resistivity becomes high if the residual amount of a solvent is less than 10% or exceeds 22%. It is believed that this is because the high-concentration conductive particle layer 44 is formed relatively thickly within a range where the residual amount of a solvent is from 10% to 22%, and the high-concentration conductive particle layer 44 is formed relatively thinly if the residual amount of a solvent is less than 10% or exceeds 22%.

Additionally, it is believed that, when the overall thickness of the high-concentration conductive particle layer is relatively large, for example, even if thickness unevenness is in the high-concentration conductive particle layer 44, the overall thickness is large; therefore the unevenness of the back resistivity caused by the thickness unevenness does not become so conspicuous. On the contrary, it is believed that, when the overall thickness of the high-concentration conductive particle layer 44 is relatively small, if thickness unevenness is in the high-concentration conductive particle layer 44, the overall thickness is small; therefore the unevenness of the back resistivity caused by the thickness unevenness become conspicuous.

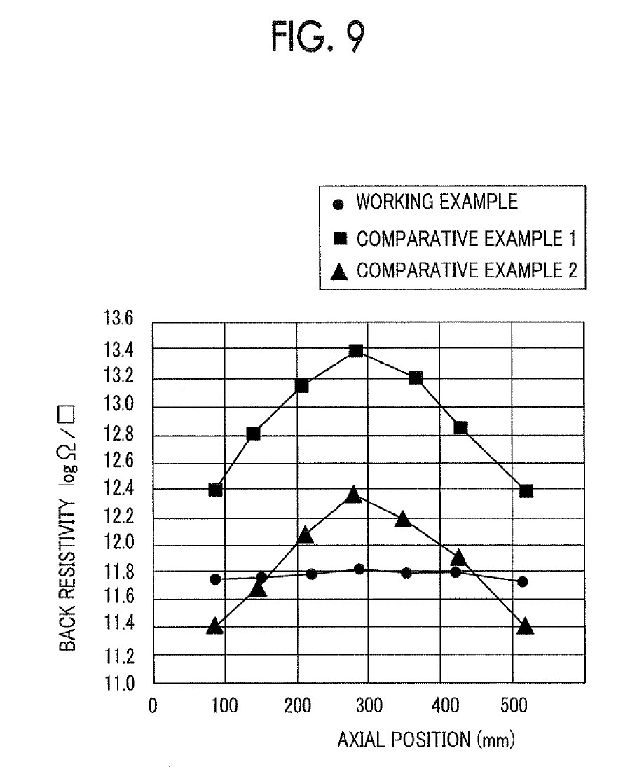

FIG. 9 shows the back resistivity to the axial position of the two-layer polyimide resin endless belt.

Working Example (black dot plotting) in the drawing shows the back resistivity to the axial position of the two-layer polyimide resin endless belt when, in the first coating film drying process, the hot-air temperature is set to 150° C., the drying time is set to 20 minutes, and drying is made so that the residual amount of a solvent of the first coating film is settled within a range of from about 10% to about 22% in the respective portions (refer to FIG. 6).

Comparative Example 1 (black square plotting) in the drawing shows the back resistivity to the axial position of the two-layer polyimide resin endless belt when, in the first coating film drying process, the hot-air temperature is set 150° C., the drying time is set to 10 minutes, and drying is made so that the residual amount of a solvent of the first coating film is settled within a range of from about 22% to 34% in the respective portions (refer to FIG. 6).

Comparative Example 2 (black triangle plotting) in the drawing shows the back resistivity to the axial position of the two-layer polyimide resin endless belt when the dispersion concentration of conductive particles of the film forming resin solution 14 used for the formation of the first coating film is increased compared to Working Example and Comparative Example 1 is made to increase, and when, similarly to Comparative Example 1, in the first coating film drying process, the hot-air temperature is set to 150° C., the drying time is set to 10 minutes, and drying is made so that the residual amount of a solvent of the first coating film is settled within a range of from about 22% to about 34% in the respective portions (refer to FIG. 6).

When Working Example is compared with Comparative Example 1, Working Example has lower back resistivity than Comparative Example 1 as a whole, and the difference (back resistivity unevenness) between the maximum and minimum of the back resistivity to the axial position in Working Example is smaller than that in Comparative Example 1. It is believed that the thickness of the high-concentration conductive particle layer 44 in the two-layer polyimide resin endless belt in Working Example is larger than that in Comparative Example 1.

Since the dispersion concentration of conductive particles in Comparative Example 2 is made higher than that in Working Example and Comparative Example 1, the back resistivity in Comparative Example 2 decreases as a whole with respect to Comparative Example 1 and the average value in Comparative Example 2 is approximately equal to that in Working Example. However, in Comparative Example 2, similarly to Comparative Example 1, the difference (back resistivity unevenness) between the maximum and minimum of the back resistivity to the axial position is large. It is believed that the thickness of the high-concentration conductive particle layer 44 in the two-layer polyimide resin endless belt in Comparative Example 2 is relatively small similarly to Comparative Example 1.

That is, it is believed that the residual amount of a solvent of the first coating film in the first coating film drying process is settled within a range of from 10% to 22% in respective portions, whereby the high-concentration conductive particle layer 44 is formed relatively thickly, and the back resistivity unevenness of the two-layer polyimide resin endless belt can be suppressed.

As described above, in the method for manufacturing a two-layer polyimide resin endless belt related to the present exemplary embodiment, the two-layer polyimide resin endless belt is manufactured by coating the film forming resin solution (the dispersion concentration of conductive particles: 22.4%) containing a PI precursor and conductive particles on the circumferential surface of the core 12 to form the first coating film (the first coating film forming process), then drying the first coating film (the first coating film drying process), then coating the film forming resin solution 15 (the dispersion concentration of conductive particles: 20.4%) containing a PI precursor and conductive particles on the dried first coating film to form the second coating film (the second coating film forming process), then drying the second coating film (the second coating film drying process), then heating the first coating film and the second coating film so that the polyimide precursors are imidized (the heating process), and then removing the first coating film and the second coating film from a core (the removing process).

Then, when the first coating film is dried, the residual amounts of a solvent of the first coating film are adapted to fall within a range of from 10% to 22% in respective portions. Thereby, the high-concentration conductive particle layer 44 is formed relatively thickly. Accordingly, the two-layer polyimide resin endless belt in which the back resistivity is kept from varying in respective portions is manufactured.

In addition, when the two-layer polyimide resin endless belt is adopted as a transfer belt of an image forming apparatus, as described above, the surface resistivity and volume resistivity of the surface and back of the two-layer polyimide resin endless belt become important electrical properties. Measurement of the surface resistivity and measurement of the volume resistivity will be described below.

(Measurement of Surface Resistivity)

The surface resistivity is a numerical value obtained by dividing a potential gradient in a direction parallel to a current that flows along the surface of a test piece by current per unit width of a surface, and is equal to the surface resistance between two electrodes when opposed sides of a square with respective sides of 1 cm are used as the electrodes. Although the unit of the surface resistivity is formally Ω, this unit is indicated as Ω/□ in order to distinguish from mere resistance.

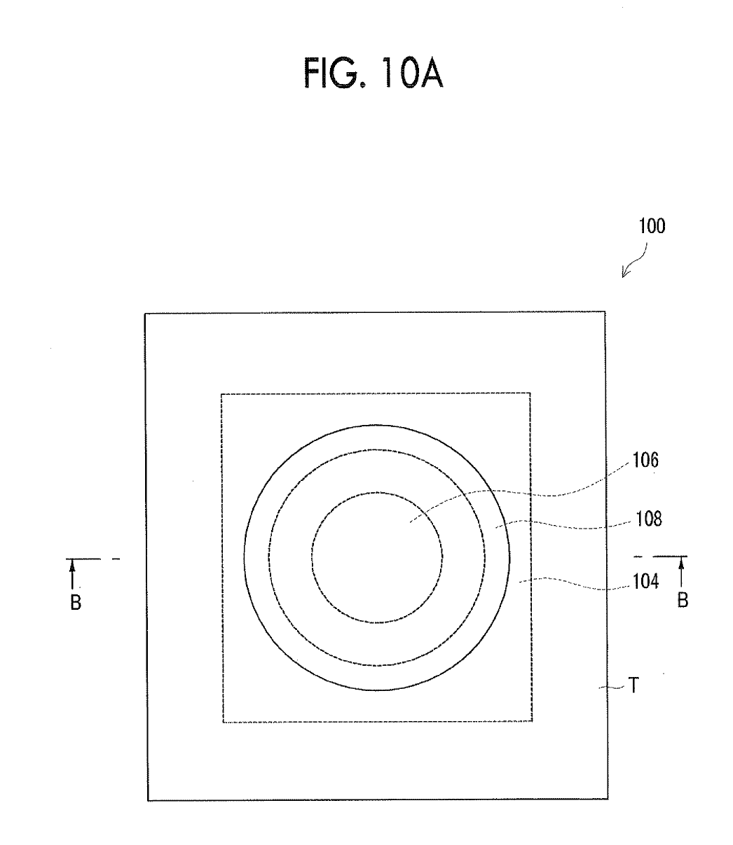

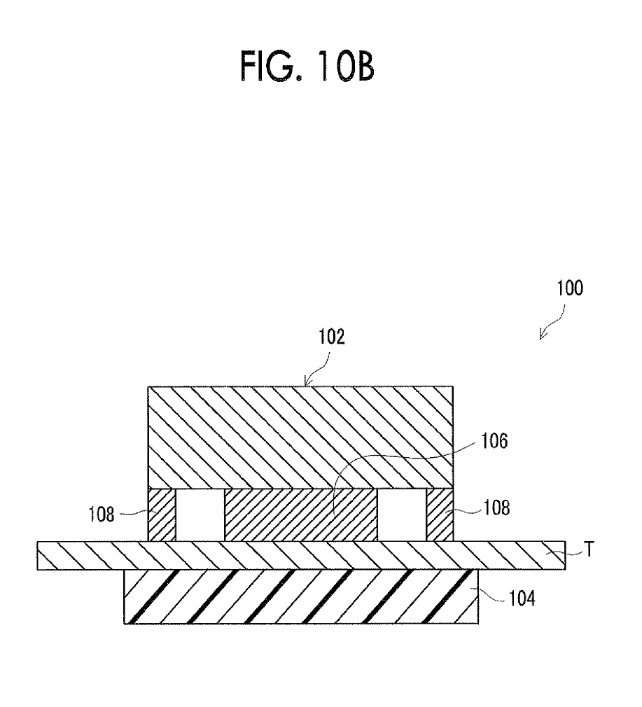

The surface resistivity is measured using a circular electrode 100 as shown in FIG. 10. FIG. 10A shows a plane of the circular electrode 100, and FIG. 10B shows a cross-section taken along the line B-B in FIG. 10A. The circular electrode 100 includes a first voltage application electrode 102 and a plate-shaped insulator 104. The first voltage application electrode 102 includes a columnar electrode portion 106, and a cylindrical ring-shaped electrode portion 108 that has a larger internal diameter than the external diameter of the columnar electrode portion 106 and surrounds the columnar electrode portion 106 at a certain distance. An object T to be measured is sandwiched between the columnar electrode portion 106 and the ring-shaped electrode portion 108 in the first voltage application electrode 102, and the plate-shaped insulator 104, and a current I(A) is measured that flows when a voltage V (V) is applied to between the columnar electrode portion 106 and the ring-shaped electrode portion 108 in the first voltage application electrode 102. The surface resistivity ρs (Ω/□) of the object T to be measured is calculated by the following Formula (1). Here, d (mm) represents the external diameter of the columnar electrode portion 106 in the following Formula (1). D (mm) represents the internal diameter of the ring-shaped electrode portion 108.

ρs=πx(D+d)/(D−d)×(V/I) Formula (1)

(Measurement of Volume Resistivity)

The volume resistivity is a numerical value obtained by dividing a current that flows through the back and front of a test piece by the thickness of the test piece, and is equal to the volume resistivity between two opposed electrodes of a cube with respective sides of 1 cm. The unit of the volume resistivity is Ωcm.

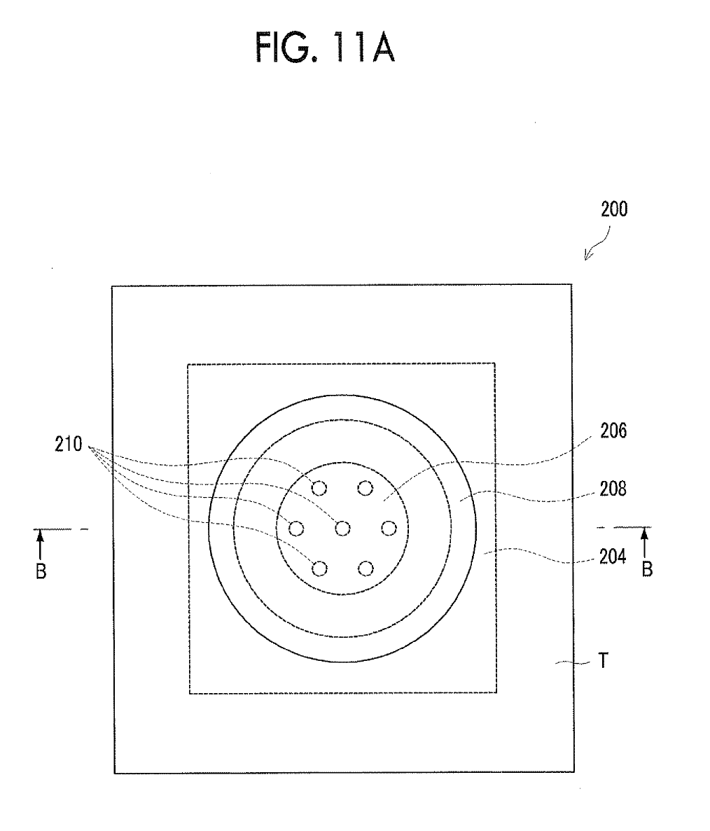

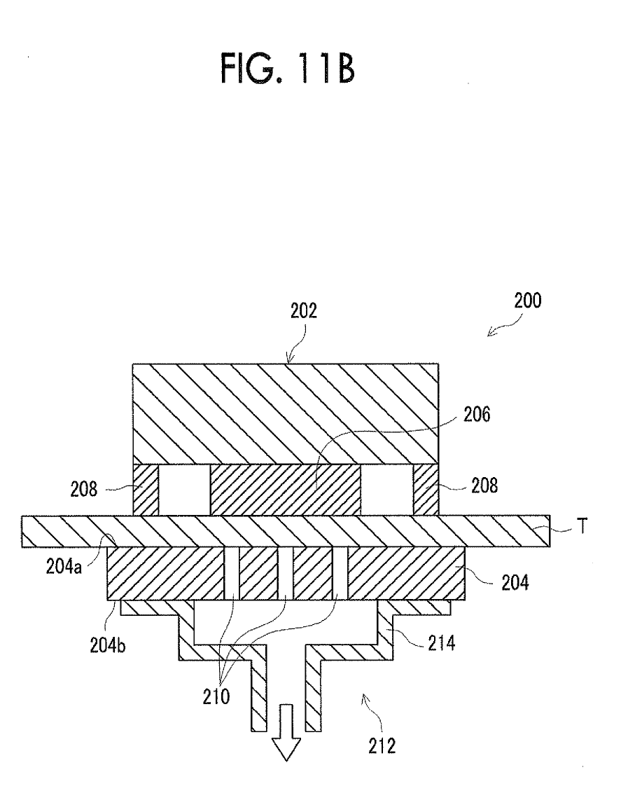

The volume resistivity is measured using a circular electrode 200 as shown in FIG. 11. FIG. 11A, shows a plane of the circular electrode 200, and FIG. 11B shows a cross-section taken along the line B-B in FIG. 11A. The circular electrode 200 includes a first voltage application electrode 202 and a second voltage application electrode 204. The first voltage application electrode 202 includes a columnar electrode portion 206, and a cylindrical ring-shaped electrode portion 208 that has a larger internal diameter than the external diameter of the columnar electrode portion 206 and surrounds the columnar electrode portion 206 at a certain interval. An object T to be measured is sandwiched between the columnar electrode portion 206 and the ring-shaped electrode portion 208 in the first voltage application electrode 202, and the second voltage application electrode 204, and a current I (A) is measured that flows when a voltage V (V) is applied to between the columnar electrode portion 206 in the first voltage application electrode 202 and the second voltage application electrode 204. The volume resistivity p92 v (Ωcm) of the object T to be measured is calculated by the following Formula (2). Here, in the following Formula (2), D (mm) represents the internal diameter of the ring-shaped electrode portion 208 and t represents the thickness of the object T to be measured.

ρv=πx(D/2)²/tx(V/I) Formula (2)

When the volume resistivity is measured by the circular electrode 200, if air enters the gap between the second voltage application electrode 204 and the object T to be measured, the accuracy of measurement is reduced. In order to suppress this, the circular electrode 200 is provided with air vent holes 210 that is formed to pass through the second voltage application electrode 204 in the thickness direction thereof, and a negative-pressure generator 212 that generates a negative pressure in the air vent holes 210.

A total of seven air vent holes 210 are provided; one air vent hole is provided in the central portion of the second voltage application electrode 204, and six air bent holes are provided at intervals of 60 degrees around the central air vent hole. The negative-pressure generator 212 is adapted so that, for example, a vacuum ejector or an air joint 214 of a vacuum pump is connected to a face 204b opposite to a face 204a with which the object T to be measured of the second voltage application electrode 204 comes into contact. In addition, as shown in FIG. 11B, one air joint 214 common to the total of seven air vent holes 210 may be provided, or air joints 214 may be provided at the seven air vent holes 210, respectively.

By bringing the second voltage application electrode 204 into contact with the object T to be measured while causing the negative-pressure generator 212 to generate negative pressure in the air vent holes 210, air is kept from entering the gap between the second voltage application electrode 204 and the object T to be measured. This enables the volume resistivity of the object T to be measured to be measured with high precision.

In addition, the air vent holes 210 may be made to generate positive pressure to blow off air toward the object T to be measured after the end of measurement of the volume resistivity. This facilitates peeling-off between the object T to be measured and the second voltage application electrode 204.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for manufacturing an endless belt comprising:
coating a solution containing a polyimide precursor and conductive particles on the circumferential surface of a core to form a first coating film;
drying the first coating film so that the residual amount of a solvent of the first coating film falls within a range of from about 10% to about 20% in respective portions;
coating a solution containing a polyimide precursor and conductive particles on the first coating film dried in the drying of the first coating film to forma second coating film;
drying the second coating film;
heating the first coating film dried in the drying of the first coating film and the second coating film dried in the drying of the second coating film so that the polyimide precursors are imidized; and
removing the first coating film and the second coating film heated in the heating of the first coating film and second coating film from a core.

2. The method for manufacturing an endless belt according to claim 1,
wherein the solution containing a polyimide precursor is obtained by causing an aromatic tetracarboxylic dianhydride to react with an aromatic diamine component.

3. The method for manufacturing an endless belt according to claim 1,
wherein carbon black is used as the conductive particles.

4. The method for manufacturing an endless belt according to claim 1,
wherein the process of drying the first coating film is carried out in a drying device at a temperature of from 100° C. to 200° C.

5. The method for manufacturing an endless belt according to claim 1,
wherein the process of drying the second coating film is carried out so that the residual amount of a solvent falls within a range of from 20% to 50%.

6. The method for manufacturing an endless belt according to claim 1,
wherein the process of heating the first coating film and the second coating film is carried out for 20 minutes to 60 minutes at 250° C. to 450° C.

7. The method for manufacturing an endless belt according to claim 1,
wherein the core material is stainless steel.
